(19) United States
(12) Patent Application Publication
(10) Pub. No.: US 2016/0121350 A1
(43) Pub. Date: May 5, 2016

(54) Hygiene device for moisturizing tissue paper

(71) Applicant: World Biotechnology LLC, North Brunswick, NJ (US)

(72) Inventor: Victor Yeung, Toronto (CA)

(21) Appl. No.: 14/531,981

(22) Filed: Nov. 3, 2014

(51) Int. Cl. B05B 11/00; A47K 10/32

(52) U.S. Cl. CPC B05B 11/3001; B05B 11/3073; A47K 10/32; A47K 2010/328

(57) ABSTRACT

A hygiene device for moisturizing tissue paper (or TP) comprising:
a load-chamber configured to contain a fluid load;
a load-exit configured to direct the fluid load to moisturize a TP;
a load-exit-seal configured to open and close the load-exit;
a piston configured to alter the load-exit-seal from the states of being opened and from being closed; and
a volume-compressor connected to the piston and configured to pressurize the load-chamber to substantially expel the fluid load;
   wherein compression of the piston opens the load-exit-seal, and pressurizes the load-chamber.

### SUMMARY

This invention intends to provide a hygiene device for moisturizing tissue paper (or TP). The TP used with this invention may be at least one square of commercially available bathroom tissue.

Fluid may be dispensed from the device using a combination of forces including; gravitation, compression, air pressure, or water pressure.

Parts

The device may comprise of a reservoir, an applicator, a valve, and a piston.

The valve may comprise of a washer, a seal, a diaphragm, an entrance, and an exit.

The piston may comprise of a housing, a chamber, a spring, a spring compressor, a volume compressor, and a ratchet.

Collectively these parts may function to contain and dispense incremental quantities of a fluid.

The quantities of fluid may be greater than 0.5 mL, less than 5.0 mL and preferably 1.0 mL.

The housing and the reservoir may be mated and fluidicly connected so that the housing functions as a leak proof bottle closure for the reservoir.

The reservoir may be fluidicly connected to the chamber and the applicator to apply fluid to a TP where it is wholly absorbed.

Piston

The housing may contain the chamber that contains the piston.

The piston may move up and down inside the chamber.

The piston may be subjected to be moved directly or indirectly by the applicator or the spring.

The applicator may have an axis of motion for a user to interact with to access the piston.

The applicator may be manufactured as separate parts and assembled around housing obstructions so that the applicator may protrude from the housing without falling out.

The piston may use a seal that can seal and unseal the chamber from the reservoir and from the applicator.

The piston may alternate between a combination of states of sealing and unsealing the chamber from the reservoir and from the applicator.

The piston may use a volume compressor to create a pressure inside the chamber to expel fluid.

The piston may use a volume compressor to create a negative pressure inside the chamber replenish fluid.

The piston may oppose the spring using a spring-compressor and compress the spring against the housing.

The spring may oppose the piston using the spring-compressor and compress the piston against a stationary housing-landing.

The spring-compressor may be permeable by fluid to so that it does not obstruct the passage of fluid.

Chamber

The chamber may contain fluid replenished from the reservoir.

The chamber may alternate between a combination of states of being sealed and unsealed from the reservoir and from the applicator.

The chamber in an undisturbed state may begin being unsealed from a reservoir and sealed from an applicator.

The chamber in a disturbed state may become sealed from a reservoir and unsealed from an applicator.

The chamber may be sealed from inside the chamber walls or outside the chamber walls.

Operation

In one embodiment, upon a user applying a force on to an applicator, the force pushes up a piston inside a chamber.

This force causes the piston to simultaneously seal the chamber from the reservoir and unseal the chamber from the applicator.

This force also compresses a spring and moves a volume compressor into the chamber causing the chamber's fluidic volume to decrease thereby causing fluid inside the chamber to be pressurized and expelled out the unsealed applicator.

The quantity of fluid expelled is wholly absorbed into the TP.

When the force is exhausted, the spring expands and pushes down the piston, the volume compressor, and the applicator to substantially return to their initial positions.

The volume compressor pushed down creates a negative pressure in the chamber that can draw fluid into the chamber from the reservoir.

In another embodiment, the device may not use a chamber.

When a user applies a force to push up the applicator, the force pushes up a piston and causes the piston to unseal the reservoir from the applicator.

Fluid can then fluid flow from the unsealed reservoir out the applicator to be wholly absorbed by TP.

The force also compresses a spring.

Thus when the force is exhausted, the spring expands and pushes down the piston, and the applicator to substantially return to their initial positions.

Vent holes in the reservoir are used to equalize pressures inside the reservoir with the external environment to aid the flow of fluid.

In another embodiment, a ratchet may be placed between the applicator and the piston.

The applicator, the ratchet, and the housing may all have teeth that engage each other to partition movements into increments that cause clicking sounds and tactile vibrations as feedback.

The device may provide a visual, audio, or vibrational feedback to the user when it is engaged to dispense fluid.

The device may receive air from an external environment so the atmospheric pressure inside the reservoir is the same as the external environment.

Air travelling inside the device may produce a sound and visual display of bubbles.

Volume

The device may dispense a measured volume of fluid over a specified area of TP.

The quantity of fluid dispensed may vary with the time interval the device is engaged by a user.

This can occur if the piston in the chamber is held in a position where both the fluid entrance and fluid exit are unsealed thereby allowing a continuous flow of fluid from the reservoir through to the applicator.

This can also occur if the piston without a chamber is held in a position where the fluid exit is unsealed thereby allowing a continuous flow of fluid from the reservoir through to the applicator.

Extras

A mounting bracket may mate with the device and be affixed to a surface next to a TP supply or TP holder.

Levers and latches may be used to secure and release the device from the mated position with the mounting bracket.

Fragrances and antiseptics may be used in the fluid.

Heating implements may be used to increase the temperature of the fluid.

Electrically powered optical sensor implements may be used to detect if a user is supplying a TP to be moisturized and initiate the device to dispense fluid and thus replace the need for the user to compress TP against the device.

The device may use a security lock to prevent tampering and theft of contents.

A cap may encapsulate the applicator and the replenishment opening to prevent tampering.

Accessory Parts

A replenishment opening may be used to provide a path between the reservoir and an external environment to facilitate replenishing fluid inside the reservoir.

A replenishment opening may function as a vent to equalize air pressure in the reservoir.

A valve may be mated with the replenishment opening.

An external implement may penetrate the replenishment opening and may be configured to replenish fluid inside the device by passing fluid into the device and depleting air and gas inside the device.

The external implement may further comprise of passages, valves, seals, and diaphragms configured to utilize the Venturi Effect during fluid replenishment to automatically stop replenishment when the reservoir is substantially full.

### BRIEF DESCRIPTION OF THE DRAWINGS

FIG. 1 is a perspective view of the device and mounting bracket with TP moisturized.

FIG. 2a is a cross section of the piston when uncompressed.

FIG. 2b is a cross section of the piston when compressed.

FIG. 3a is an explosion view of the piston and reservoir assembly.

FIG. 3b is as flattened perspective of the housing surface.

FIG. 3c is as flattened perspective of the housing, applicator, and ratchet.

FIGS. 3d, 3e, 3f, 3g, and 3h are flattened perspectives of an assembly of the housing, applicator, and ratchet arrangements.

FIG. 4a is a cross section of the piston without a chamber when uncompressed.

FIG. 4b is a cross section of the piston without a chamber when compressed.

### DETAILED DESCRIPTION

In the following description, the use of “a”, “an”, or “the” can refer to the plural. All examples given are for clarification only, and are not intended to limit the scope of the invention.

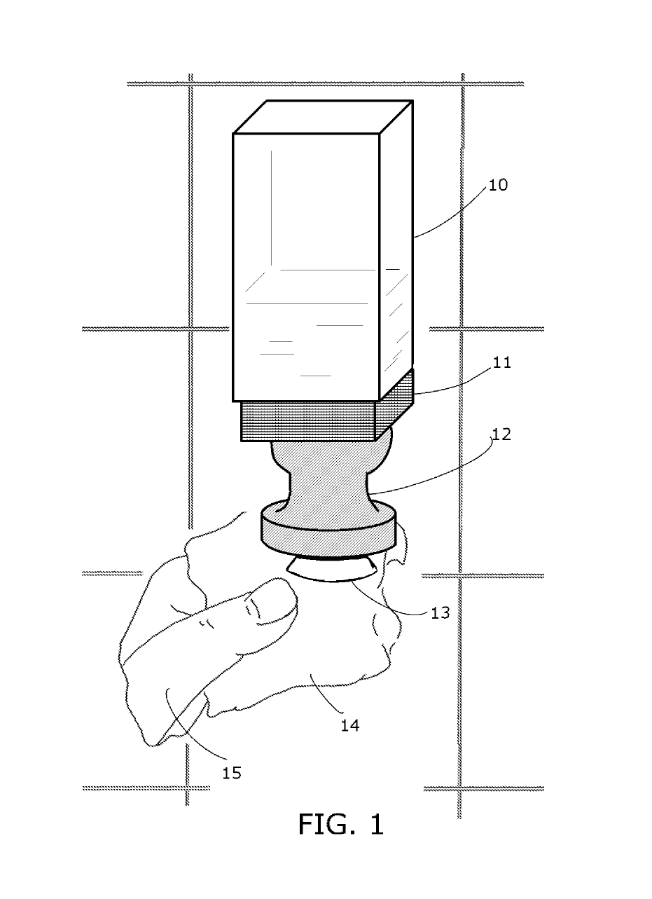

Referring to FIG. 1,

a device for moisturizing TP includes:

a reservoir 10,

a mounting bracket 11,

a housing 12,

and an applicator 13.

The reservoir 10 may be a glass, plastic, or metal container.

The reservoir 10 may be oriented with the applicator 13 at a lower elevation than the top surface of the fluid inside the reservoir 10.

The mounting bracket 11 may be designed in several configurations to secure the positioning of the device and to resist forces applied to the device by a user 15.

The housing 12 may partially contain the applicator 13 wherein the applicator 13 protrudes out the housing 12.

The housing 12 restricts the applicator 13 to a linear axis of motion with no rotation.

The applicator 13 expels out fluid from the reservoir 10 inside the device to be wholly absorbed by the TP 14.

The housing 12 and applicator 13 may be oriented so that the applicator 13 has a vertical axis of motion.

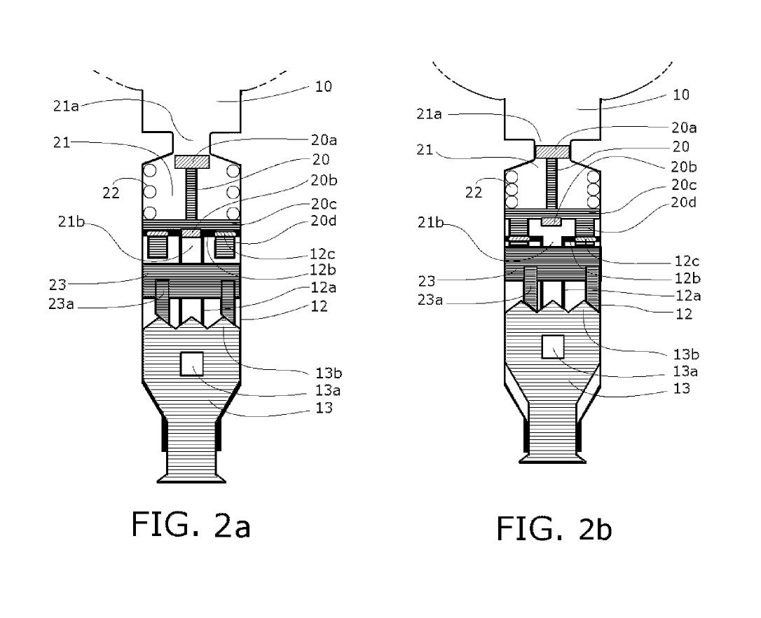

Referring to FIG. 2a, in an embodiment the reservoir 10 is connected to the housing 12.

Fluid in the reservoir 10 travels through the load entrance 21a into the load chamber 21.

The fluid may not leak out of the load chamber 21 because the load exit seal 20b is closed.

The piston 20 is primarily positioned inside the load chamber 21 along with a spring 22.

The piston 20 has extremities including a load entrance seal 20a, a load exit seal 20b, and a volume compressor 20d.

The volume compressor 20d penetrates the housing perforation 12c.

The housing landing 12b is below the spring 22 and constricts the spring 22 into tension with the spring-compressor 20c.

The ratchet 23 is between the applicator 13 and the piston 20 and provides a movement intermediary that aids the partition of applicator 13 movements into separate increments that may cause clicking sounds and tactile vibrations.

In operation, when the device is not disturbed, the spring 22 has enough tension force to keep the spring compressor 20c substantially compressed against the housing landing 12b.

The force of the spring 22 keeps the piston 20 down and the load exit 21b closed thereby preventing fluid from exiting the load chamber 21.

The force of the spring 22 keeps the load entrance 21 a open so that fluid can enter the load chamber 21 flow from the reservoir 10.

The force of the spring 22 keeps the applicator 13 down and restricted in the housing 12. (Note this is not precisely depicted here due to the depicted space between the volume compressor 20d and the ratchet 23.)

Referring to FIG. 2b,

when a user 15 engages the device, TP 14 is compressed against the applicator 13 which is subjected to the axis of movement provided by the housing 12 and opposed by the resistance force provided by the spring 22.

As the applicator 13 moves up through the housing 12, it pushes up the ratchet 23, the volume compressor 20d, the piston 20 including all its extremities, and compresses the spring 22.

In operation, when the applicator 13 is pushed up, the load entrance 21a is closed by the load entrance seal 20a preventing more fluid from entering the load chamber 21, and the load exit seal 20b is opened allowing fluid inside the load chamber 21 to go out the load exit 21b.

As the volume compressor 20d is pushed up into the load chamber 21, the fluidic volume of the load chamber 21 decreases by more than any increases thereby caused.

The decrease in volume creates a pressure inside the fluid chamber 21.

This pressure urges fluid inside the load chamber 21 to be expelled out the load exit 21b, through the applicator 13, and onto the TP 14.

The spring 22 is compressed between the spring compressor 20c and the housing 12.

When the upward force supplied by the applicator 13 is exhausted, the spring 22 expands and pushes down all the respective parts down the housing 12 and thereby seals the load exit 21b and refills the load chamber 21 by opening the load entrance seal 20a as shown in FIG. 2a.

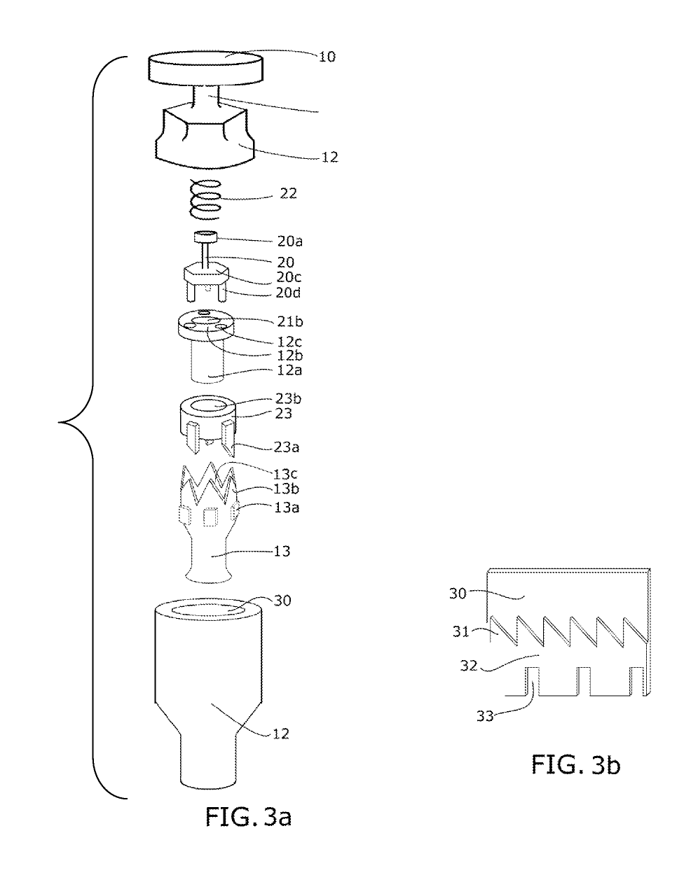

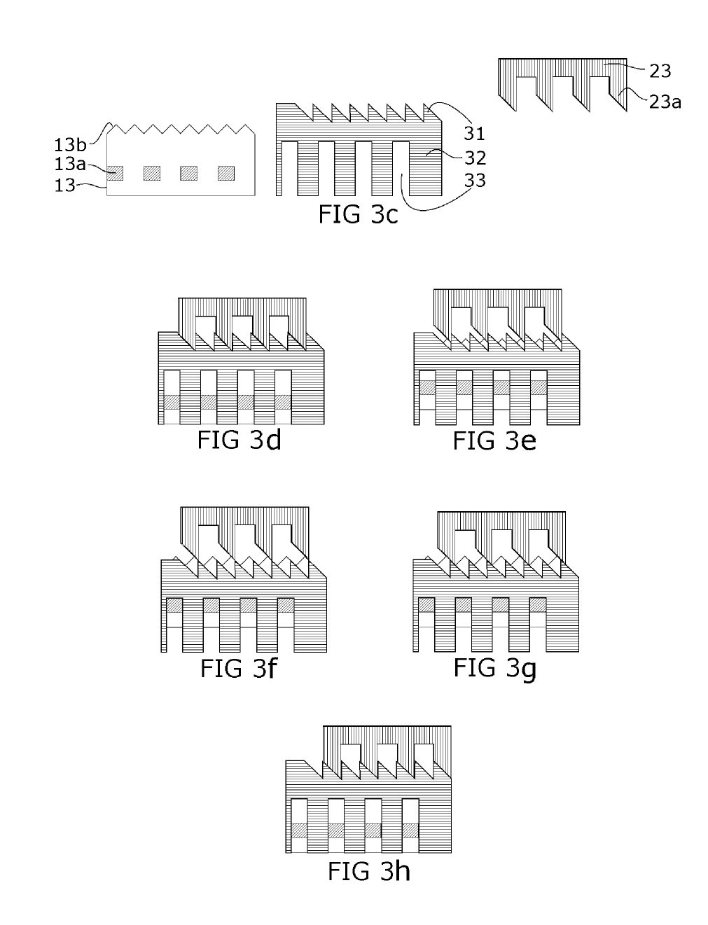

The ratchet 23 in operation will be discussed more thoroughly in FIG. 3a.

Referring to FIGS. 3a and 3b,

the applicator 13 fits inside the housing 12 and moves along the housing inner raised surface 32.

The applicator 13 has an applicator guide 13a to guide it along housing groves 33 on the inner raised surface 32 so that the applicator 13 has a fixed axis of motion and cannot rotate.

The housing pillar 12a penetrates the ratchet 23 and the applicator 13 through the ratchet core 23b and the applicator core 13c.

The housing pillar 12a is connected to the housing landing 12b which remains stationary inside the housing 12.

The housing landing 12b may manufactured as separate piece that can be fitted, glued, welded, or sonic welded onto the housing 12.

The applicator 13 has a set of applicator teeth 13b, the ratchet 23 has a set of ratchet teeth 23a, and the housing 12 has a set of housing teeth 31.

The housing teeth 31 are on the housing inner surface 30.

The ratchet 23 can rotate inside the housing 12 around the housing pillar 12a.

The ratchet 23 can move up and down inside the housing 12 along the housing pillar 12a.

The ratchet 23 has its lowest elevation when the peak of ratchet teeth 23a are engaged with the bottom of the housing teeth 31.

The spring compressor 20c, and the housing 12 are hexagonally shaped so that the piston 20 cannot rotate thereby helping ensure the volume compressor 20d is aligned to penetrate the housing perforation 12c.

In operation, when the user 15 pushes up the applicator 13, the initial contact between the applicator teeth 13b and the ratchet teeth 23a is along their respective diagonal surfaces wherein the bottoms of the applicator teeth 13b and the peak of the ratchet teeth 23a do not contact.

As the applicator 13 moves up it pushes up the ratchet teeth 23a which are subject to move up along the vertical walls of the housing teeth 31.

Eventually when the ratchet teeth 23a move above the vertical walls of the housing teeth 31, the ratchet teeth 23a will be unrestricted to suddenly move down and rotate until they meet the bottoms of the applicator teeth 13b.

This downward rotational movement by the ratchet 23 is caused by the compression force of the spring 22.

The collision of the ratchet teeth 23a with the bottoms of the applicator teeth 13b will create a first clicking sound and tactile vibration.

As the ratchet 23 continues to be pushed up by the force on the applicator 13, it pushes up the volume compressor 20d and enters the chamber 21 where it creates a pressure force.

As the ratchet 23 continues to be pushed up, it also pushes up the piston 20, and the spring compressor 20c, and compresses the spring 22.

When the user 15 begins to disengage the applicator 13, the compression force of the spring 22 pushes down the spring compressor 20c, the volume compressor 20d, the piston 20, the ratchet 23, and the applicator 13.

As the ratchet 23 comes down it is restricted and obstructed by the applicator 13.

Eventually the ratchet teeth 23a will contact the housing teeth 31 which will subject the ratchet teeth 23a to disengage from the applicator teeth 13b and the ratchet teeth 23a will suddenly be unrestricted to move along the diagonal surface of housing teeth 31.

This allows the ratchet 23 to suddenly rotate and cause the collision of the vertical surfaces of ratchet teeth 23a and housing teeth 31 thereby creating a second clicking sound and tactile vibration.

Referring to FIG. 3c,

the applicator 13, the ratchet 23, and the housing inner raised surface 32 collectively have layers that interact.

Referring to FIGS. 3d, 3e, 3f, 3g, and 3h,

the applicator 13, the housing inner surface 32, and the ratchet 23 may interact with each other to open and close the load exit 21b with a precision dictated by the timing the parts move and interact.

Referring to FIG. 3d,

the ratchet 23 is at its lowest elevation where the ratchet teeth 23a are interlocked with the housing teeth 31.

The applicator 13 is at its lowest elevation where the applicator teeth 13b do not touch the ratchet teeth 23a.

The applicator guides 13a, are subject to move along the path provided by the housing groves 33.

The load exit 21b is sealed.

Referring to FIG. 3e,

the applicator 13 pushes up the ratchet 23.

The ratchet teeth 23a are subject to move up along the vertical surface of the housing teeth 31.

The load exit 21b is opened.

Referring to FIG. 3f,

the applicator 13 has reached maximum elevation allowed by the housing groves 33.

The applicator 13 has pushed the ratchet teeth 23a above the vertical surface of the housing teeth 31.

The ratchet 23 is unrestricted to move down and rotate to the right. This would be encouraged by compression force of the spring 22.

Referring to FIG. 3g,

the ratchet 23 has moved down and rotated to the right and thereby allowed the piston 20 and its extremities to move down and seal the load exit 21b.

The ratchet teeth 23a collide with the bottom of the applicator teeth 13b and create a first clicking sound and tactile vibration.

The applicator 13 is still at its maximum elevation.

Referring to FIG. 3h,

the applicator 13 is lowered and the applicator teeth 13b disengage from the ratchet teeth 23a.

The ratchet teeth 23a collide with the housing teeth 31 and create a second clicking sound and tactile vibration.

The ratchet 23 is now at its lowest elevation.

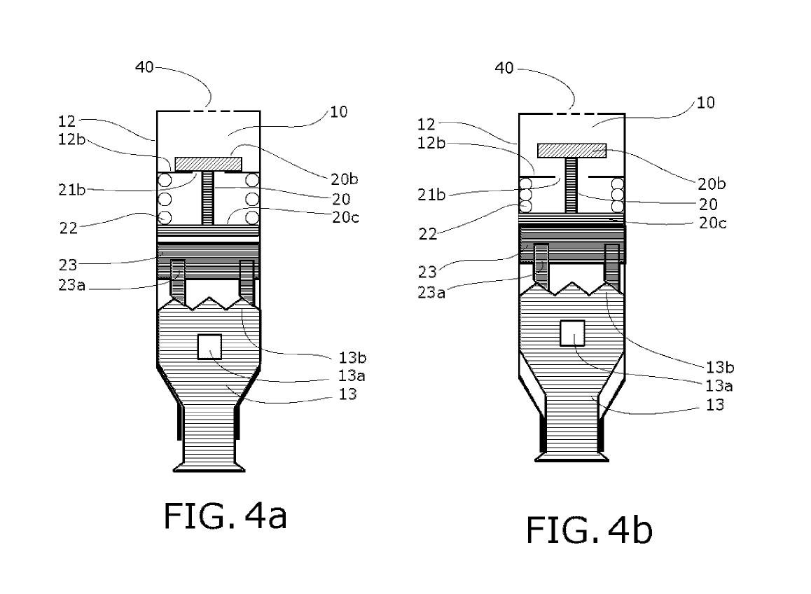

Referring to FIG. 4a,

in another embodiment, the load chamber 21, and volume compressor 20d are excluded.

The load exit seal 20b is inside the reservoir 10 where it seals the load exit 21b.

The housing landing 12b is above the spring 22 and constricts the spring 22 into tension with the spring-compressor 20c.

When the device is at rest, the spring 22 pushes down the spring compressor 20c which pulls down the piston 20 and the load exit seal 20b thereby sealing the load exit 21b.

Referring to FIG. 4b,

when the user 15 pushes up the applicator 13, it pushes the ratchet 23, which pushes the spring compressor 20c, which pushes up the piston 20, which compresses the spring 22, and unseals the load exit seal 20b and opens the load exit 21b.

Vents 40 allow air pressure in the reservoir 10 to equalize with the external environment.

Fluid in the reservoir 10 is free to flow down through the load exit 21b, and through the housing 12, ratchet core 23b, applicator core 13c, and moisturize TP 14 held against the applicator 13.

The spring 22 is compressed between the spring compressor 20c and the housing landing 12b.

When a user 15 disengages the device, the spring 22 expands and pushes back down all the respective parts down the housing 12 thereby sealing the load exit 21b.

1. A TP moisturizing device comprising:
a load-chamber configured to contain a fluid load;
a load-exit configured to direct the fluid load to moisturize a TP;
a load-exit-seal configured to open and close the load-exit;
a piston configured to alter the load-exit-seal from the states of being opened and from being closed; and
a volume-compressor connected to the piston and configured to pressurize the load-chamber to substantially expel the fluid load;
wherein the fluid load expelled is wholly absorbed into the TP, and
wherein compression of the piston opens the load-exit-seal, and pressurizes the load-chamber.

2. The TP moisturizing device in claim 1
further comprising:
a reservoir configured to contain a fluid to pass to the load-chamber;
a load-entrance configured to receive a fluid from the reservoir; and
a load-entrance-seal configured to open and close the load-entrance,
wherein compression of the piston closes the load-entrance seal,
wherein decompression of the piston opens the load-entrance seal, and
wherein decompression of the piston closes the load-exit seal.

3. The TP moisturizing device in claim 1,
further comprising:
a spring configured to compress the piston to the state of closing the load-exit-seal;
a spring-compressor connected to the piston and configured to oppose the spring; and
a housing-landing configured to constrict the spring into tension with the spring-compressor,
wherein compression of the piston moves the spring-compressor to compress the spring,
wherein decompression of the piston moves the spring-compressor to expand the spring, and
wherein the housing-landing is stationary.

4. The TP moisturizing device in claim 1,
wherein inside the housing-landing is penetrated by the volume-compressor.

5. The TP moisturizing device in claim 1,
wherein the volume-compressor can create a negative pressure in the load-chamber to draw fluid into the load-chamber.

6. The TP moisturizing device in claim 1,
further comprising an applicator configured to move the piston.

7. The TP moisturizing device in claim 1,
further comprising a ratchet configured to partition movements of the applicator,

8. The TP moisturizing device in claim 7,
wherein the ratchet provides feedback to indicate the device has been engaged with clicking sounds and tactile vibrations.

9. The TP moisturizing device in claim 2,
wherein the load-entrance-seal being opened and the load-exit-seal being closed are substantially simultaneous states; and
wherein the load-entrance-seal being closed and the load-exit-seal being opened are substantially simultaneous states.

10. The TP moisturizing device in claim 1,
wherein the load-exit-seal provides a leak proof seal sufficient to withstand the load-chamber containing the fluid, and
wherein the fluid is water.

11. The TP moisturizing device in claim 1,
further comprising a mounting bracket configured to fix the device's position on a surface adjacent to a TP supply.

12. The TP moisturizing device in claim 1,
further comprising:
a replenishment opening configured to connect the reservoir with an external environment for fluid replenishment; and
a replenishment seal configured to open and close the replenishment opening.

13. The TP moisturizing device in claim 12,
further comprising an external implement configured to,
a. penetrate the replenishment opening,
b. alter the replenishment seal from the states of being open and being closed,
c. replenish fluid inside the device,
d. exhaust gas inside the device, and
e. utilize the Venturi Effect to automatically stop the process of fluid replenishment.

14. A method of moisturizing TP comprising:
a. providing the device in claim 1;
b. compressing a TP against the device to compress the piston;
c. opening the load-exit-seal;
d. pressurizing the load-chamber to expel the fluid load out the load-exit to moisturize the TP;
e. closing the load-exit-seal.

15. A method of moisturizing TP, comprising:
a. providing device in claim 2;
b. compressing a TP against the device to compress the piston;
c. closing the load-entrance-seal;
d. opening the load-exit-seal;
e. pressurizing the load-chamber to expel the fluid load out the load-exit to moisturize the TP;
f. closing the load-exit-seal;
g. opening the load-entrance-seal;
h. expanding the volume of the load-chamber; and
i. replenishing the load-chamber with fluid.

16. A TP moisturizing system comprising the TP moisturizing device in claim 1.

17. A TP moisturizing device comprising:
a reservoir configured to contain a fluid supply;
a load-exit configured to direct the fluid to moisturize a TP;
a load-exit-seal configured to open and close the load-exit;
a piston configured to alter the load-exit-seal from the states of being open and being closed;
a spring configured to compress the piston to the state of closing the load-exit-seal;
a spring-compressor connected to the piston and configured to oppose the spring; and
a housing-landing configured to constrict the spring into tension with the spring-compressor,
wherein compression of the piston compresses the spring,
wherein decompression of the piston expands the spring, and
wherein the housing-landing is stationary.

18. The TP moisturizing device in claim 17,
further comprising:
an applicator configured to move the piston; and
a ratchet configured to partition movements of the applicator,
wherein when the applicator is pushed up the ratchet moves up and down, and
wherein when the ratchet moves down the load-exit-seal closes and limits the fluid exiting to a quantity wholly absorbable into the TP.

19. The TP moisturizing device in claim 17,
wherein the load-exit seal provides a leak proof seal sufficient to withstand the reservoir full of water.

20. A method of moisturizing TP comprising:
a. providing the device in claim 17;
b. compressing the TP against the device to move the piston;
c. opening the load-exit-seal;
d. pressurizing fluid in the load-chamber to expel out the load-exit to moisturize the TP;
e. uncompressing the TP against the device; and
f. closing the load-exit-seal.
